(19) United States
(12) Patent Application Publication
(10) Pub. No.: US 2012/0005615 A1
(43) Pub. Date: Jan. 5, 2012

(54) METHOD FOR EXECUTING AN INPUT BY MEANS OF A VIRTUAL KEYBOARD DISPLAYED ON A SCREEN

(75) Inventor: Alexander Gruber, Berlin (DE)

(73) Assignee: zero1.tv GmbH

(21) Appl. No.: 13/178,206

(22) Filed: Jul. 7, 2011

(30) Foreign Application Priority Data
Jan. 26, 2009 (DE) DE200910006082
Jan. 26, 2009 (DE) DE200910006083
Jan. 26, 2010 (DE) PCT/DE2010/000073

(51) Int. Cl. G06F 3/048

(52) U.S. Cl. 715/773

(57) ABSTRACT

A method is described for executing an input using a virtual keyboard which is displayed on a screen and on which each key is represented by an object displayed on the screen. In said method, the three-dimensional position of at least one input object relative to a plane is monitored, the position of the input object parallel to the plane represents a selected spot on the screen, a key of the virtual keyboard represented by an object is highlighted on the screen when the selected spot in the display on the screen is located within the object, an approach of the input object towards the plane is monitored, and a highlighted object is selected and a function associated with the key that is represented by the displayed object is input when the input object moves closer to the plane than a given distance and/or approaches the plane at a speed that is higher than a given approach speed.

### CROSS-REFERENCE TO RELATED APPLICATIONS

This application is a continuation application of International Application No. PCT/DE2010/000073 filed Jan. 26, 2010, which claims priority to German Patent Application No. DE200910006083, which was filed on Jan. 26, 2009; and German Patent Application No. DE200910006082, which was filed on Jan. 26, 2009, all of which are hereby incorporated by reference in their entirety.

### BACKGROUND

There are an increasingly large number of electronic entertainment devices in households, for example, television sets with or without recording function, video recorders, removable media playback devices and/or playback recorders, hard-disk recorders, set-top boxes, high-fidelity amplifiers, play consoles, media center personal computers (PC), and similar devices, to name only a few.

Electronic entertainment devices have further been developed in recent years as powerful devices that can be compared in their performance to early personal computers. The performance includes computing power, the capability of displaying graphical elements, as well as the possibilities of data storage in persistent and non-persistent storage elements. This technical development further makes possible the use of operating systems and complex software for controlling the functionality of electronic entertainment devices. No end of this development is in sight.

As a result of this development, electronic entertainment devices are already increasingly used as a media archive and thus ensure access to thousands of media files such as film, music, photos and the like.

Moreover, novel services with novel content are offered that expand the classic information offers and for which likewise novel reproduction devices and/or recording devices are offered. So-called “video on demand” services, based on streaming or download that can be reproduced on television sets by means of suitable set-top boxes or by suitable, usually digital recorders are cited here.

There are offers and services even in the area of video-on-demand that make available to a user a large library of media that can be retrieved in a time-independent manner. The user is presented here with the challenge of finding the content that appeals to him personally from the totality of the offer. Search functionalities play a central part here. Thus, users can allow the entire offer to be filtered in accordance with their instructions in order to find the desired content.

An inputting of written characters such as, for example, letters, numbers and the like is a prerequisite for a logical utilization of a search function.

There is the problem here that the input devices of electronic entertainment devices are suitable only to a limited extent for ensuring the input of written characters.

### BRIEF DESCRIPTION OF THE DRAWINGS

Examples of a system that displays input from a three-dimensional input device on a two-dimensional display. The examples and figures are illustrative rather than limiting.

FIG. 1 shows a schematic view of a virtual keyboard displayed on a screen.

FIG. 2 shows a schematic view of a plane relative to which the spatial position of at least one input object is monitored, in a top view.

FIG. 3 shows the plane of FIG. 2 in a lateral view.

FIG. 4 shows a schematic view of a transposing of an input object parallel to the plane onto the virtual keyboard on the screen.

FIG. 5 shows a schematic view of a highlighting of a key of the virtual keyboard, which key is represented by an object, on the screen on the basis of the identified position of an input object.

FIG. 6 shows a schematic view of a monitoring of an approach of the input object to the plane.

FIG. 7 shows a schematic view of a function associated with the key represented by a highlighted object.

### DETAILED DESCRIPTION

Described below is a method of entering written characters, for example, letters and numbers as input information into electronic devices.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

Electronic entertainment devices are primarily controlled by remote controls. These remote controls offer various combinations of switches, buttons, rotary wheels, movement detection sensors, joysticks, etc. as user interfaces for control.

One of the greatest insufficiencies of current remote controls is the fact that they are unsuitable, on account of their so-called form factor, i.e., their dimensions and the switches, buttons, rotary wheels, movement detection sensors, joysticks, etc. arranged on them, for displaying, for example, all characters, for example, of the alphabet in order to make possible in this manner, e.g., an inputting of a combination of characters and/or numbers, e.g. of a text, on an electronic entertainment device. For this reason a keyboard overlay on a screen of an electronic entertainment device, which overlay is designated in the following as a virtual keyboard, is currently primarily used for making an input possible. Each key of the virtual keyboard is represented by an object displayed on the screen.

This virtual keyboard is controlled, for example, by arrow keys on the remote control. This has the disadvantage that the input takes place only slowly since long paths must be traversed between the keys displayed on the screen and representing individual letters.

As already mentioned, the convergence of electronic entertainment devices and personal computers continues to advance and even the applications that are to be used on them increasingly resemble each other in the area of entertainment. Thus, for example, there have been products for quite some time that are intended to make it possible to use typical PC applications, for example, on the screen of a television set. This makes possible the access to the Internet and World Wide Web via Internet browsers, as well as the use of communication applications such as email and instant messaging on a television set.

For example, a rapid and comfortable inputting of keyboard characters is unavoidable for these applications. For this reason a classic keyboard has previously usually been provided as input device for this purpose, where the input device is connected by cable or wirelessly, for example, via radio- or infrared technology, to the television set.

However, it turned out that the size of the input devices of an electronic entertainment device, for example, of a television set or other device connected to a television set is a critical element for the user. If an input device exceeds a certain size, it is not accepted by the user.

Accordingly, a problem of the invention can be considered to be the development of a method that makes possible a rapid and flowing input at least of written characters and instructions and commands on a remote screen under preservation of the restrictions regarding the accepted form factor.

A method in accordance with the invention for executing an input or a remote input, e.g., for the inputting of instructions or commands, written characters such as, for example, numerals, letters and the like by means of a virtual keyboard displayed on a screen, in which keyboard each key of the keyboard is represented by an object displayed on the screen, provides that the spatial position of at least one input object relative to a plane is monitored; the position of the input object parallel to the plane represents a selection point on the screen; a key of the virtual keyboard, which key is displayed by an object, is displayed highlighted, enlarged, brightened and or otherwise highlighted on the screen if the selection point is located in the screen display inside the object; an approach of the input object to the plane is monitored; and upon an approach of the input object to within a given distance of the plane and/or upon an approach with an approach speed greater than a given one a highlighted object is selected and a function associated with the key represented by the displayed object is used for the input.

In order that a highlighted object is retained during the approach, for example, upon an unintentional changing of the position of the input object parallel to the plane, a highlighted object is fixed preferably during an approach with an approach speed higher than a given approach speed.

In some embodiments, the fixing is canceled again if the approach speed during the approach drops again below the given approach speed or below a given, lower value than the given approach speed.

In some embodiments, a key of the virtual keyboard, represented by an object, is displayed highlighted, enlarged, brightened or otherwise highlighted on the screen when the selection point approaches the object.

According to an embodiment of the invention, a display of a key of the virtual keyboard is represented by an object, and the display of the object is highlighted, for example, enlarged, brightened or otherwise highlighted, is canceled again on the screen when the selection point is removed from the object.

In some embodiments, an object is highlighted in that it is displayed in a semitransparent manner and enlarged on the screen.

An embodiment of the invention provides that upon contact of the plane with the input object, a highlighted object is selected and a function, associated with the key of the virtual keyboard, is used for the input.

The input preferably takes place into an input field also displayed on the screen.

In some embodiments, the function associated with the key of the virtual keyboard, which key is represented by the object displayed on the screen, comprises a written character such as, for example, a letter or a number and/or an instruction such as, for example, an input instruction to be applied to the input field displayed on the screen, such as for example, a return or a switching instruction for capitalization, writing umlauts, writing numbers, whereby the screen display or a selection of the keys displayed on the screen preferably changes in accordance with the switching instruction.

In some instances, in a first view, only a part of the objects representing keyboard keys associated with written characters are displayed on the screen. If required, the display on the screen changes to, for example, a second view by selecting an object provided for this purpose. The second view has objects that represent another part of the keyboard keys associated with written characters.

In some instances, a division of the entire set of written characters into three or four views is performed, for example, a) lower-case letters, b) upper case letters, c) numbers and special characters, d) other special characters.

The plane can be formed, for example, by a pressure-sensitive touch pad or by a light-emitting diode field.

According to an embodiment of the invention, two or more input objects can be provided whose positions are represented parallel to the plane by their own selection point on the screen.

The input object can be at least one finger of at least one hand of a user.

An embodiment of the invention provides that the selection point is represented by, for example, a circular, half- or semitransparent, selection object on the screen.

Inside the selection object a function, associated with a key represented by an object that is currently being passed over, is displayed on the screen in order to highlight the key.

The size of the selection object as well as the display of the function associated with a key represented by an object that is currently being passed over are increased on the screen the further the input object is removed from the plane.

The virtual keyboard can advantageously be triggered or activated or launched by various triggers. A distinction is to be made here between contextual-content-related triggers and hardware-conditioned or controlled triggers.

Launching of the virtual keyboard can take place by a contextual-content-related pulse created by the software application. If the processing device requires an input in the form of letters, numbers or other characters, the virtual keyboard can be activated. This also leads to an activation of the input device. A contextual-content-related pulse can be produced by the selection of an input field, contact form or the like.

The virtual keyboard can advantageously also be activated by hardware pulses, for example, the pressing of a button, switching a switch. It is also possible to identify the position of the input device in space via sensors (for example, by accelerators) and to activate the virtual keyboard in this manner.

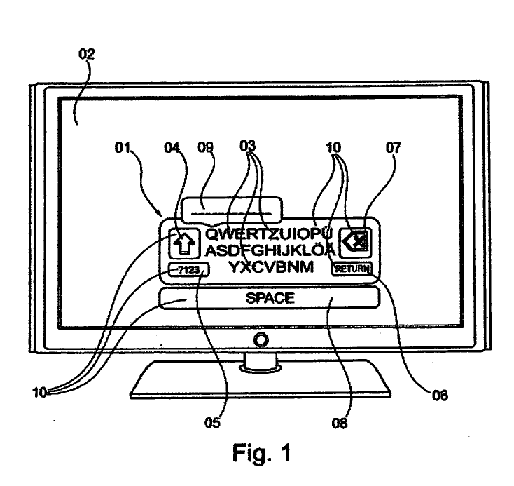

FIG. 1 shows a virtual keyboard 01 displayed on a screen 02. Each key of keyboard 01 is represented by an object 10 displayed on screen 02. The display of objects 10 on screen 02 comprises, for example, the function associated with the keys of virtual keyboard 01, which keys are represented by objects 10, which functions are, for example, written characters 03, switching instructions for capitalization 04, for writing numbers 05, input instructions 06, deleting- or backspace instructions 07 and blank space 08. Virtual keyboard 01 deviates, for example, in the arrangement and division of its keys on the screen 02 from a standard keyboard like the one used, for example, with personal computers. This can be advantageous since it is not possible, for example, conditioned by the resolution and/or the number of pixels, to display all elements of a keyboard in one view, for example, on a screen 02 of a television set. Objects 10 representing keys are preferably distributed within several views. It is possible to switch between the views by selecting objects 10 representing keys and expressly provided to this end, for example, by objects 10 displaying the switching instructions for capitalization 04 and for number writing 05. A typical arrangement of the keys of virtual keyboard 01 is a view of the letters in querty/qwertz or in alphabetical arrangement. In addition, in some embodiments, there are separate views for inputting numbers, special characters and capital letters. A display of the virtual keyboard as a numeric field is also possible that uses the inputting of characters by multiple occupations. Here, each number is occupied by several letters that can be clicked through by multiply pressing a number key. This form of input is customary when using keyboards on mobile telephones and is also widespread in the area of operating, e.g., television sets. Word recognition systems such as, for example, T9, that suggest possible words to the user on the basis of inputted characters, have proven themselves as a supplement to this form of input. This reduces the number of characters to be inputted and raises the operating comfort.

An input by virtual keyboard 01 preferably takes place into an input field 09 that is also displayed on screen 02.

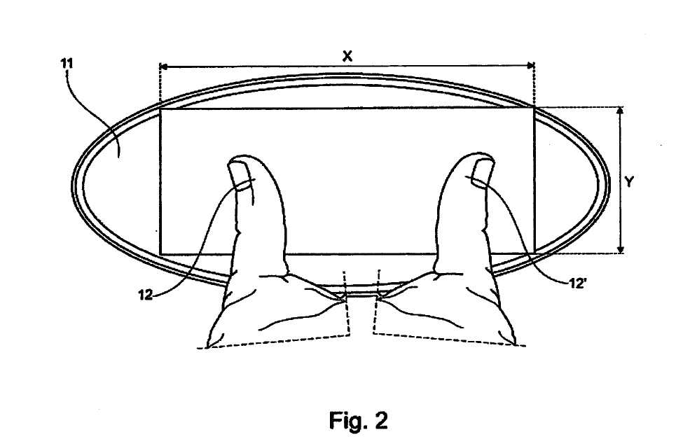

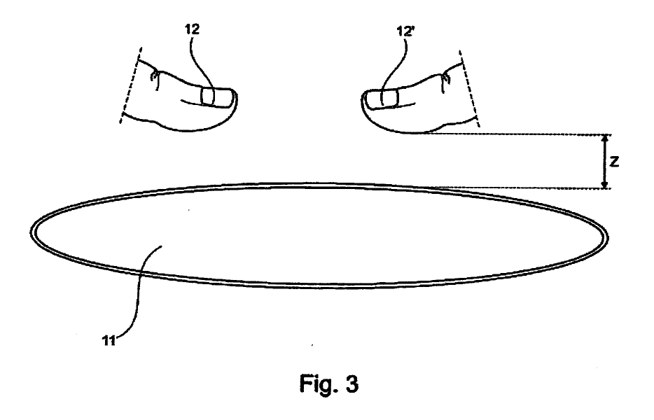

FIG. 2 shows a top view onto a plane 11, relative to which the spatial position of at least one input object 12, 12′, for example, of one or more fingers 12, 12′ of one or both hands of a user, a pen or a pen-like pointing device or the like is monitored. Plane 11 is a component of an input device for controlling virtual keyboard 01. It is preferably an input device that is capable, based on light-emitting diodes, of simultaneously recognizing the position of one or several objects, generally designated as input objects 12, 12′, such as fingers 12, 12′, in three-dimensional space. The input device is preferably operated by fingers 12, 12′. The input device supplies an X-, Y- and a Z value (FIG. 3) upon the recognition of the spatial position of an input object 12, 12′ relative to a plane 11.

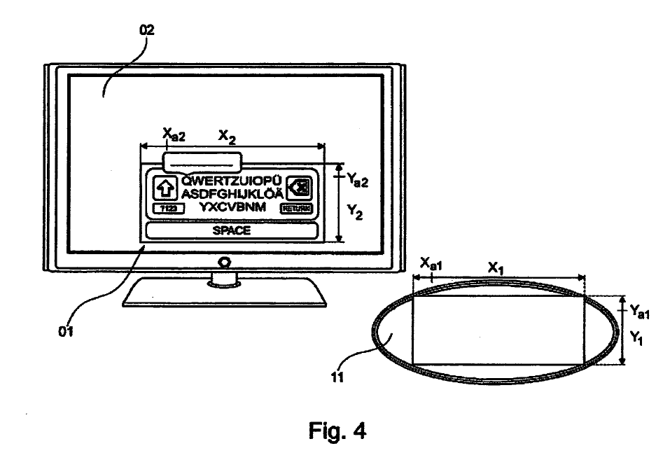

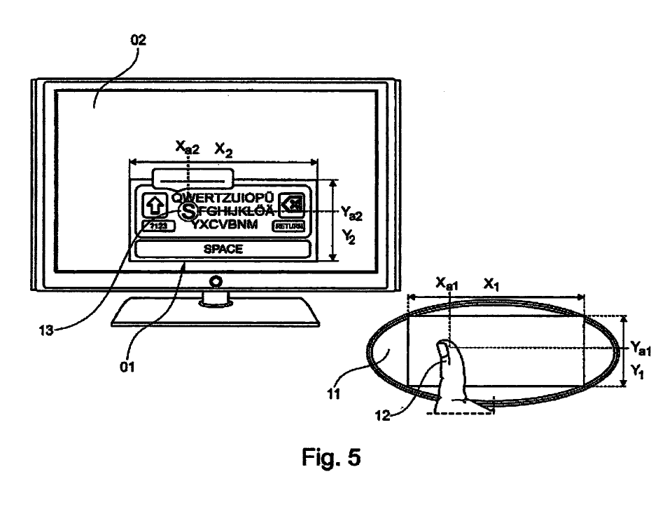

FIG. 3 shows plane 11 from FIG. 2 in a lateral view. Input objects 12 located above the surface of plane 11 are recognized. The distance of an input object 12 to plane 11 is indicated as a Z value by the input device. The position of input object 12 parallel to plane 11 is indicated by the input device with an X- and with a Y value (FIGS. 4 and 5). Thus, the position of the input object 12 is completely described in a three dimensional space above plane 11 by an X value, Y value and Z value. The X, Y and Z values, indicating a position of input object 12, subsequently form input coordinates for the execution of an input by virtual keyboard 01.

Alternative to the described input device that makes possible the recognition of positions of an input object 12 in space by a field of light-emitting diodes, also designated as an array, alternative systems for the recognition of positions in three-dimensional space can also be used. This includes pressure-sensitive touchpads, optical systems with camera support, as well as any system capable of identifying the position of an object, for example, using an X, Y and Z value in a space.

The data transmission between input device and the processing device can take place via wireless transmission paths such as, for example, using radio or infrared signals. A cable-bound transmission is also conceivable.

FIG. 4 shows the transposing of the input coordinates formed by X and Y values parallel to plane 11 onto virtual keyboard 01 on screen 02. X₁ indicates the total width of the recognition range above plane 11. This range is represented on screen 02 by the range X₂, which extends over or covers, in some instances, the entire width of virtual keyboard 01. If the input device recognizes an input object 12 at position xₐ₁, the corresponding value xₐ₂ is calculated with the following formula for display on screen 02:

xₐ₂=(xₐ₁*X₂)/X₁.

Y₁ indicates the total depth of the recognition range above plane 11. This range is represented on screen 02 by the range Y₂, which extends over or covers, in some instances, the entire height of virtual keyboard 01. If the input device recognizes an input object 12 at position yₐ₁, the corresponding value yₐ₂ is calculated with the following formula for display on screen 02:

yₐ₂=(yₐ₁*Y₂)/Y₁.

A schematic representation of a highlighting of a virtual keyboard key represented by an object on the screen based on the identified position of an input object

The position of input object 12 parallel to plane 11 is represented by a selection point on screen 02. The selection point is represented on screen 02 in the form of, for example, a circular, and in some instances, half- or semitransparent, selection object 13. As a result, only the X and Y values are required to represent the position of selection object 13. FIG. 5 shows the overlay of a selection object 13 on the basis of the identified position of an input object 12 parallel to plane 11. If the input device recognizes an input object at a position (xₐ₁/yₐ₁) above plane 11, selection object 13 is displayed on screen 02 at position (xₐ₂/yₐ₂).

A key of virtual keyboard 01 which key is represented by an object 10 is displayed emphasized on screen 01, for example, by enlargement, brightening or in general by highlighting if the selection point represented preferably by selection object 13 is in the screen display inside object 10 and/or in its vicinity. The function associated with a particular key of virtual keyboard 01 such as, for example, a written character or instruction is preferably displayed inside selection object 13 for highlighting, which function is represented by object 10 currently being passed over by selection object 13. Expressed in simpler terms, the character of virtual keyboard 01, which character is currently being passed over, is displayed inside selection object 13.

Upon an approach of input object 12 within a given distance to plane 11 and/or upon an approach with an approach speed greater than a given one, a highlighted object 10 is selected and a function associated with the key represented by displayed object 10 is used for the input into input field 09.

This corresponds to a key pressure on a classic keyboard.

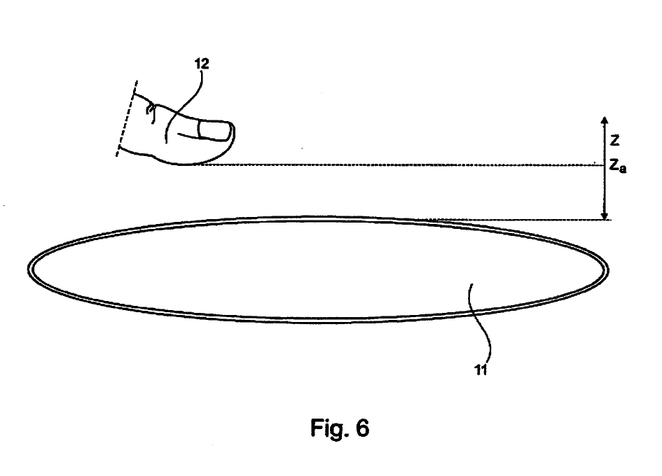

FIG. 6 schematically shows a monitoring of an approach of an input object 12 to plane 11. To this end the distance of input object 12 indicated by the Z value to plane 11 is determined. Z indicates the total measuring range of the height or distance. Selection object 13 preferably appears on screen 02 as soon as an input object 12 is within the entire measuring range Z.

In FIG. 6 zₐ designates the Z value of input object 12 as the distance of input object 12 to plane 11. In some embodiments, the Z value influences the size of the display of selection object 13 on screen 02. In some embodiments, the size of selection object 13 changes dynamically with the Z value. For example, selection object 13 becomes smaller if the Z value is smaller.

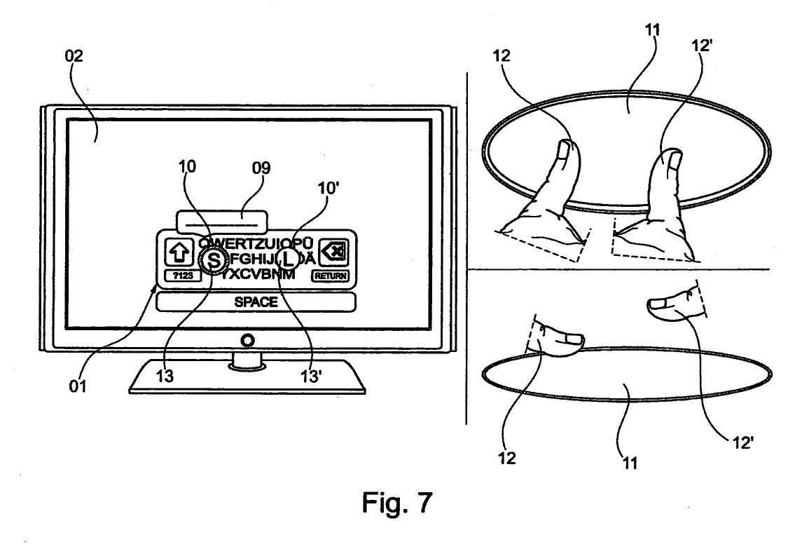

FIG. 7 shows how a selection of characters on virtual keyboard 01 takes place by the selection of functions associated with keys represented by highlighted objects 10, 10′. The operation of virtual keyboard 01 takes place here with two input objects 12, 12′, whose positions parallel to plane 11 are represented on screen 02 by their own selection points displayed by a selection object 13, 13′.

The selection of a character preferably takes place via a rapid reduction of the distance of an input object 12, 12′ from plane 11. As a result thereof, the Z value is reduced, for example, down to the value 0. This means that an input object 12, 12′ rapidly approaches plane 11 and, for example, touches it. The contact of plane 11 corresponds, for example, to a Z value of Z=0. This is called a pressure process in the following. It is also basically conceivable to select a character upon an approach of input object 12 below a given distance to plane 11 and/or upon an approach with an approach speed greater than a given approach speed. If a threshold value s₁ is exceeded, for example, during the acceleration and/or approach speed of an input object 12, 12′, the X value and the Y value are stored, i.e., fixed at this point in time. After this point in time the display of selection object 13 is fixed and is no longer updated until the Z value has dropped to 0.

This prevents an unintended movement in the X and the Y direction during the pressure process from influencing the selection of the keyboard character and the character desired by the user not being selected.

If an input object 12, 12′ touches plane 11 (Z=0), the character is selected that corresponds to the X and Y coordinates at time s₁, i.e., that was passed over by selection objects 13, 13′ at time s₁. This is designated as a virtual key press. The virtual key press can be corroborated for the user, for example, by an audiovisual acknowledgment. Likewise, a tactile acknowledgment is possible. A key press on virtual keyboard 01 can initiate various actions.

1. A keyboard character was pressed. The character is transmitted into input field 09.

2. A switching key was pressed. The view of virtual keyboard 01 changes, typically, a switch is made between uppercase writing and lowercase writing, numbers and special keys.

3. An action key was pressed. The action is executed. This is typically actions such as closing the keyboard, input 06, delete characters 07, etc.

If a user decides to halt the pressure process before he has touched plane 11, it is advantageous to cancel the fixing again. To this end, in some instances, another threshold value s₂ is defined. If the approach speed of an input object 12, 12′ falls below this threshold value, the fixing is cancelled again.

The control of virtual keyboard 01 can take place via a blind control also called eyeless control. This means that there is control of the input device without having to look at the input device itself. While the viewing angle of the user is directed onto screen 02, it is possible for the user by virtue of the method of the invention to control, for example, with his fingers the selection objects 13, 13′ that serve to control virtual keyboard 01.

The use of virtual keyboard 01 with fingers 12 is similar to, thanks to the method in accordance with the invention, the use of a classic keyboard like that known, for example, for personal computers. Using the virtual keyboard 01 with the aid of a three-dimensional recognition system described by the method of the invention gives the user, for the first time, a user experience similar to that of a classic keyboard.

The user is capable, by virtue of the three-dimensional recognition, of aiming at a key, represented by an object 10, 10′, on virtual keyboard 01 with a finger 12, 12′ without touching plane 11. Object 10, 10′ is displayed highlighted on screen 02 as soon as it is located inside a selection object 13, 13′. While the user approaches plane 11 with one of his fingers 12, 12′, the indicated selection object 13, 13′ focuses the highlighted object 10, 10′. The user can correct the position of finger 12, 12′ in order to aim at the key on virtual keyboard 01 which key is represented by highlighted object 10, 10′.

It is important to emphasize that the invention can be used with any input system that recognizes a position of an input object in a three-dimensional space. Thus, the invention can be used, for example, with an input device that determines the position of one or more input objects in space with the aid of an array of light-emitting diodes. The invention can also be used with a pressure-sensitive touchpad that, in some instances, can recognize two or more pressure stages. The invention can also be used with an approach-sensitive field that operates with other technologies than an array of light-emitting diodes. The invention can also be used with camera-based methods, that make possible a three-dimensional recognition of a position of one or more input objects. In sum, the invention can be used in combination with any method that makes possible a three-dimensional recognition of a position.

The invention makes it possible to execute an input of commands and characters with the aid of a system for the three-dimensional recognition of a position of an input object by means of a virtual keyboard.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

What is claimed is:

1. A method, comprising:
monitoring a three-dimensional position of an input object wherein the three-dimensional position comprises a height position of the input object relative to a plane and a two-dimensional position parallel to the plane, and further wherein the two-dimensional position corresponds to coordinates on an output device;
monitoring a rate of change of the height position of the input object;
highlighting a display object at the coordinates on the output device and updating the highlighting responsive to the monitored two-dimensional position; and
discontinuing the highlighting updates when the rate of change of the height position of the input object exceeds a first threshold.

2. The method of claim 1, further comprising resuming the highlighting updates responsive to the monitored two-dimensional position if the rate of change of the height position of the input object decreases to below the first threshold.

3. The method of claim 1, further comprising resuming the highlighting updates responsive to the monitored two-dimensional position if the rate of change of the height position of the input object decreases to below a second threshold, wherein the second threshold is lower than the first threshold.

4. The method of claim 1, further comprising:
displaying on the output device a part of a virtual keyboard, wherein the part includes a character key;
displaying an input field on the output device; and
when the highlighted display object is the character key, and the character key is selected, place the character in the input field.

5. The method of claim 1, further comprising:
displaying a first view of a virtual keyboard on the output device, wherein the first view of the virtual keyboard includes a switch key; and
changing the first view to a second view of the virtual keyboard when the highlighted display object is the switch key, and the switch key is selected, wherein the second view includes a portion of the virtual keyboard not displayed in the first view.

6. The method of claim 1, further comprising:
displaying a part of a virtual keyboard on the output device, wherein the part of the virtual keyboard includes an action key; and
executing an action associated with the virtual keyboard when the highlighted display object is the action key, and the action key is selected.

7. The method of claim 1, further comprising displaying a virtual keyboard on the output device when prompted by a software application.

8. The method of claim 1, further comprising displaying a virtual keyboard on the output device in response to a hardware trigger.

9. The method of claim 1, further comprising changing a size of the highlighted display object on the output device based on the height position of the input object.

10. The method of claim 1, wherein the input object is a finger of a hand.

11. The method of claim 1, wherein the highlighted display object is identified by a semi-transparent geometric shape around the display object.

12. The method of claim 1, wherein the highlighted display object is enlarged.

13. The method of claim 1, further comprising upon contact of the plane with the input object, selecting the highlighted displayed object.

14. A system, comprising:
an input device configured to monitor a three-dimensional position of an input object, wherein the three-dimensional position comprises a height position of the input object relative to a plane and a two-dimensional position parallel to the plane; and
a processor coupled to the input device and configured to:
monitor a rate of change of the height position of the input object;
convert the two-dimensional position to coordinates on an output device;
highlight a display object at the coordinates on the output device and update the highlighting responsive to the monitored two-dimensional position; and
discontinue the highlighting updates when the rate of change of the height position of the input object exceeds a first threshold.

15. The system of claim 14, wherein the processor is further configured to resume the highlighting updates responsive to the monitored two-dimensional position if the rate of change of the height position of the input object decreases to below the first threshold.

16. The system of claim 14, wherein the processor is further configured to resume the highlighting updates responsive to the monitored two-dimensional position if the rate of change of the height position of the input object decreases to below a second threshold, wherein the second threshold is lower than the first threshold.

17. The system of claim 14, wherein the processor is further configured to:
display on the output device a part of a virtual keyboard, wherein the part includes a character key;
display an input field on the output device; and
when the highlighted display object is the character key, and the character key is selected, place the character in the input field.

18. The system of claim 14, wherein the processor is further configured to display on the output device a first view of a first part of a virtual keyboard that includes a switch key and to display a second view of a second part of the virtual keyboard on the output device when the switch key is the display object, and the switch key is selected, and further wherein the second view includes a portion of the virtual keyboard not displayed in the first view.

19. The system of claim 14, wherein the processor is further configured to display on the output device a part of a virtual keyboard that includes an action key and to execute an action associated with the virtual keyboard when the action key is highlighted as the display object, and the action key is selected.

20. The system of claim 14, wherein the processor is further configured to display a virtual keyboard on the output device in response to a software trigger.

21. The system of claim 14, wherein the processor is further configured to display a virtual keyboard on the output device in response to a hardware trigger.

22. The system of claim 14, wherein the processor is further configured to change a size of the highlighted display object on the output device based on the height position of the input object.

23. A system, comprising:
means for monitoring a three-dimensional position of an input object wherein the three-dimensional position comprises a height position of the input object relative to a plane and a two-dimensional position parallel to the plane, and further wherein the two-dimensional position corresponds to coordinates on an output device;
means for monitoring a rate of change of the height position of the input object;
means for highlighting a display object at the coordinates on the output device and means for updating the highlighting responsive to the monitored two-dimensional position; and
means for discontinuing the highlighting updates when the rate of change of the height position of the input object exceeds a first threshold.

24. The method of claim 23, further comprising upon contact of the plane with the input object, means for selecting the highlighted displayed object.
